(19) United States
(12) Patent Application Publication
(10) Pub. No.: US 2002/0020702 A1
(43) Pub. Date: Feb. 21, 2002

(54) Food container to be treated by electronic oven and packaged food using this container

(76) Inventors: Ichiro Matsuno, Saitama-ken (JP); Kohei Asada, Saitama-ken (JP); Keisuke Shimizu, Tokyo (JP); Hirotaka Sasaki, Saitama-ken (JP)

Correspondence Address: BIRCH STEWART KOLASCH & BIRCH, PO BOX 747, FALLS CHURCH, VA, 22040-0747, US

(21) Appl. No.: 09/817,131

(22) Filed: Mar. 27, 2001

(30) Foreign Application Priority Data
Mar. 28, 2000 (JP) 2000-088325

(51) Int. Cl. H05B 6/80

(52) U.S. Cl. 219/734; 219/732

(57) ABSTRACT

Here is disclosed a microwave transmissive container used to heat precooked food filled therein in a microwave oven, comprising a bottom plate, a side wall extending upward from periphery of the bottom plate and a cap bonded to upper edge of the side wall to close the container, the container being characterized by that: the bottom plate is provided in the vicinity of its central zone with a hollow prominence extending through the bottom plate upward to a level such that a top vent hole of the prominence lies an upper space within the container so that vapor generated from upper surface of the precooked food as it is heated in the microwave oven may be taken in by the top vent hole of the prominence and guided to lower side of the bottom plate.

In this way, the container for food adapted to be heated in the microwave oven and the food package using such container improved so that vapor generated from upper surface of precooked food filled therein such as frozen food may be effectively used to heat portions of precooked food lying in the vicinity of the container's central and lower zones and thereby the content may be evenly and quickly heated.

### TECHNICAL BACKGROUND

The present invention relates to a food container filled with precooked food (referred to hereinafter simply as ‘precooked food’ so far as otherwise specified) such as gratin, lasagna or curry and rice. Such precooked food filled in the container is adapted for normal temperature preservation, refrigerating preservation or freezing preservation so that it may be heated by microwave immediately before actual use. The present invention relates also to a food package using such food container.

More particularly, the present invention relates to such food container and food package enabling the precooked food filled therein to be evenly heated and enabling a heating time to be remarkably reduced.

Various types of food package have already been commercially available, which are filled with precooked food and preserved by freezing so that these food packages may be merely heated in a microwave oven immediately before actual use.

The container used for such food package of prior art is usually made of microwave transmissive material. When the food package is heated in the microwave oven, the upper layer as well as the portion of the precooked food lying in the vicinity of the sidewall of the container can be quickly heated. However, a temperature rise of the precooked food is relatively delayed in the vicinity of the container's bottom plate, particularly in the vicinity of the bottom plate's central zone. Consequently, unevenness of heating effect is not avoidable in the precooked food as a whole.

Such unevenness of heating effect is significant particularly when the precooked food in the form of frozen food is heated in the microwave oven. This phenomenon has been reported to be due to the characteristics of the microwave emitted from a magnetron of the microwave oven.

Specifically, the frozen food is generally preserved at a temperature lower than −18° C. and its moisture content is present in a state of ice. A permittivity of the microwave through a mass of ice is substantially lower than in water and considerably high energy is required to convert its state from ice to water. Once the mass of ice has been converted to the state of water, the permittivity of microwave abruptly increases. It has been reported that a temperature rising rate may consequently reach a level as high as approximately 400 times the rate observed in the ice phase.

The permittivity of microwave largely depending on the state of medium in this manner causes a troublesome phenomenon when frozen food filled in the container is heated in the microwave oven. Specifically, the portion of ice lying in the vicinity of the food's top layer and the container's side wall readily irradiated with the microwave is quickly converted to the state of water. As a result, these portions of the food are selectively accelerated to be heated. However, the remainder portion lying in the vicinity of the bottom plate's central zone is not easily converted to the state of water. In this manner, a differential heating effect occurs between these portions.

Upon completion of heating the entire food to a desired temperature, the portions having been earlier thawed are in excessively heated state, which leads to undesirably cooked food in taste as well as in texture.

To solve the problem as has been described above, there have been developed various types of container improved to minimize said unevenness of heating effect.

For example, it has already been proposed that the central zone of the container's bottom plate, which would otherwise be hard to be heated, is raised. This proposal intends thereby to accelerate a temperature rising rate in this portion. The food package has also been proposed in which the peripheral (side) wall or at least the inner surface thereof is coated with microwave reflecting or non-transmissive material. According to this proposal, the other portions of the container such as rim (flange) or corners also may be coated with said material. In addition, the bottom (bottom plate) may be formed by microwave transmissive material in accordance with this proposal (Japanese Patent Publication No. 1984-6789).

Japanese Patent Application Disclosure Gazettes Nos. 1986-173028; 1987-282556; 1991-176131 and 1996-324653 also have proposed the food containers adapted to be heated in the microwave oven intending to overcome the above-mentioned problem. The disclosures in these Gazettes are commonly characterized in that the container's cap (lid) is provided at its top or the like with a vent hole or an exhaust port. This is for the purpose of exhausting water vapor generated from the precooked food's top layer quickly heated to prevent the top layer portion from being excessively heated. Such propose also intends thereby to minimize the uneven heating effect.

While these various types of container intending to heat the precooked food as evenly as possible, all of these proposals have left the problems behind incompletely solved. In the case of the container having the bottom raised in its central zone, a volume available to be filled with the precooked food should be correspondingly reduced. Though the temperature rise is accelerated to some degree by raising the central zone of the container bottom, the problem of the uneven heating effect is still not overcome. Furthermore, the raised bottom is accompanied with an additional problem that the container becomes bulky for its capacity to be filled with the precooked food.

Improvement disclosed by said Japanese Patent Publication No. 1984-6789 lies merely in the side wall or the flange and the corners of the container coated with microwave non-transmissive material. Certainly, such countermeasure is effective to inhibit an abrupt temperature rise of the precooked food in the vicinity of the coated region of the container. However, it is impossible for this countermeasure to prevent the precooked food from being excessively heated in the vicinity of its top layer. Particularly in the vicinity of the bottom plate's central zone, the effect of microwave still remains low. Therefore, it is impossible for this arrangement disclosed in said Publication No. 1984-6789 to heat evenly the entire precooked food.

The containers disclosed in said Japanese Patent Application Disclosure Gazettes Nos. 1986-173028; 1987-282556; 1991-176131; and 1996-324653 are commonly characterized in the feature as follows: the container's cap or the like is provided with the vent hole or exhaust port through which the water vapor generated on the top surface of the precooked food may be exhausted. Certainly, such arrangement is effective to prevent the precooked food's top layer from being excessively heated. However, it is impossible for this arrangement to prevent the precooked food from being excessively heated in the vicinity of the container's side wall. Additionally, a lot of time is taken until the entire content reaches a desired temperature without elimination of the unevenness in the heating effect. Furthermore, the water vapor at a high temperature can not be efficiently utilized since such water vapor must be exhausted to the exterior to avoid a dangerous bursting of the container.

As has been described above, none of the conventional food container adapted to be heated in the microwave oven is able to heat evenly the precooked food evenly filled in the container. With a consequence, the manner of using the container is disadvantageously limited.

In view of the problem as has been described hereinabove, the present invention aims to achieve the even heating effect for the precooked food filled in the container. The present invention intends to achieve this by accelerating the portion of the precooked food lying in the vicinity of the central zone, particularly of the bottom's central zone of the container.

It is one object of the present invention to provide a container for precooked food adapted to be heated in a microwave oven improved to solve the problem left behind by the prior art. It is another object of the present invention to provide a food package using this container. The novel container intends to use water vapor generated from food's top surface efficiently to accelerate food's portions lying in the vicinity of its central and bottom zones.

### DISCLOSURE OF THE INVENTION

The objects set forth above are achieved, according to first and second aspects of the present invention, by an improvement in the container for food adapted to be heated in the microwave oven and the food package using said container.

The container for food adapted to be heated in the microwave oven is made of microwave transmissive material. The container comprises a bottom plate, a side wall extending upward from periphery of said bottom plate and a cap bonded to upper edge of said side wall to close the container.

The improvement according to the first aspect of the present invention is characterized by that said bottom plate is provided in the vicinity of its central zone with a hollow prominence extending through the bottom plate upward to a level such that a top vent hole of the prominence lies an upper space within the container so that vapor generated from upper surface of the precooked food as it is heated in the microwave oven may be taken in by the top vent hole of the prominence and guided to lower side of the bottom plate.

According to one preferred embodiment of the present invention, the bottom plate or side wall is provided with a leg extending downward from the bottom plate or side wall by a height of 3˜10 mm. According to another preferred embodiment of the present invention, said bottom plate is provided around an opening from periphery of which the prominence extends upward with difference in level stepwise rising toward the central zone of the container.

The food package comprising said container filled with precooked food adapted to be heated in microwave oven, said food package being characterized by that vapor generated from upper surface of the precooked food as it is heated in the microwave oven may be taken in by the top vent hole of the prominence and guided to lower side of the bottom plate so that the portions of precooked food lying in the vicinity of the container's central and lower zones may be accelerated to be heated.

According to one preferred embodiment of this food package, the food package is entirely coated with synthetic resin film and a portion of this synthetic resin film coating the container's bottom may be provided with an exhausting port for the vapor. According to another preferred embodiment of this food package, the exhausting port maybe provided in the vicinity of the central zone of the container's bottom.

### BRIEF DESCRIPTION OF THE DRAWINGS

FIG. 1(A) is a perspective view showing a first embodiment of the container for precooked food adapted to be heated in microwave oven according to the present invention;

FIG. 1(B) is an axially sectional view of this first embodiment;

FIG. 2(A) is a perspective view showing a second embodiment of the container for precooked food adapted to be heated in microwave oven according to the present invention;

FIG. 2(B) is an axially sectional view showing this second embodiment;

FIG. 3(A) is a perspective view showing a third embodiment of the container for precooked food adapted to be heated in microwave oven according to the present invention;

FIG. 3(B) is an axially sectional view showing this third embodiment;

FIG. 4 is a perspective view showing a first example of the conventional container for precooked food adapted to be heated in microwave oven as a first control;

FIG. 5 is a perspective view showing a second example of the conventional container for precooked food adapted to be heated in microwave oven as a second control; and

FIG. 6 is a plan view illustrating temperature measured spots within a food package adapted to be heated in microwave oven.

Reference numerals used in the drawings respectively designate: bottom plate by 10; opening in the bottom plate by 10a, 10a′; difference in level by 10b; prominence by 11; vent hole in the prominence by 11a; closure by 12; side wall by 20; leg by 21; flange by 22; cap by 30; and temperature measured spots by T1˜T4.

### PREFERRED MANNERS IN WHICH THE INVENTION IS EXECUTED

The present invention will be more fully understood from the description given hereunder on the basis of the preferred embodiments.

The present invention relates to a container for food made of microwave transmissive material and adapted to be heated in microwave oven. The invention relates also to a food package comprising precooked food filled in this container so as to be heated in the microwave oven immediately before it is actually used. The container may be made of composite material such as glass, ceramics or paper as base material coated with synthetic resin or microwave transmissive material such as synthetic resin. From the viewpoint of cost, the container is preferably made of synthetic resin.

Suitable synthetic resin may be selected from a group of thermoplastic synthetic resins including polyethylene, polypropylene, polystyrene, polyethylene terephthalate, polyvinyl chloride, and polyacrylonitrobutadiene styrene. The resin may be successively subjected to steps of sheet forming, vacuum forming, air pressure forming and compression molding to obtain the container. Alternatively, the molten resin may be subjected to an extrusion process to obtain the container.

A space of the container to be filled with precooked food is defined a bottom plate and a side wall extending upward from periphery of this bottom plate.

The bottom plate or the side wall may be provided, if necessary, with a leg extending downward from said bottom plate or side wall by a length of 3˜10 mm. The leg may extend downward from a lower side of the bottom plate or continuously extend downward from the sidewall. The presence of such leg facilitates vapor to be guided and the microwave reflected upward by bottom of the oven to be directed to the lower side of the bottom plate.

A cap made of microwave transmissive material is bonded to upper edge of the side wall to close the container. If desired, the side wall may be provided on its top end with a flange (or collar) extending horizontally (i.e., in parallel to the bottom plate). In this case, said cap may be bonded to this flange after the container has been filled with precooked food, or before or after freezing of said precooked food.

According to the invention, a portion of the bottom plate in the vicinity of its central zone is provided in the form of a hollow prominence. This prominence continuously extends upward from the remaining portion of the bottom plate to define a passage along which vapor can flows downward.

As will be described later more in detail, water vapor is generated from top surface of precooked food as it is heated in the microwave oven. The passage functions to take in the vapor through a vent hole formed in the top of the prominence and to guide it toward the lower side of the bottom plate. However, it is apprehended that the presence of this vent hole might cause various problems. For example, precooked food might be partially forced out to the lower side of the container or cling to outer surface of the passage during the step of filling. These problems may deteriorate a commercial value of the article. To eliminate such apprehension, size, shape and construction of the vent hole may be appropriately adjusted. For example, a diameter of the vent hole may be reduced or the vent hole is provided in the form of a slit.

According to the second aspect of the present invention, the cap made of microwave transmissive material is bonded to said container after filled with precooked food to obtain the food package. In this food package, the container is filled with precooked food up to a level slightly lower than the level at which the vent hole of the prominence is positioned.

Upper layer portion of precooked food filled in the container is heated more quickly than the remaining portion as the food package is heated in the microwave oven. Thereupon, vapor, particularly water vapor is generated from the upper surface of said upper layer portion. The vapor fills a head space of the container, then an excess thereof is taken in through the vent hole into the passage. In this manner, the vapor is guided downward along the passage to the lower side of the bottom plate.

The portions of precooked food lying in the vicinity of the prominence and the bottom plate, i.e., the central and bottom zones of the container are thereby accelerated to be heated.

In this way, the portions of precooked food lying in the central and bottom zones are accelerated to be heated by efficiently utilizing the vapor. Thereby the entire content can be evenly heated and a time required for heating can be reduced.

It is possible without departing from the scope of the invention to coat said food package with synthetic resin film In this case, this film on the bottom of the container may be formed with an exhaust port for the vapor.

The vapor generated from the upper surface of precooked food as this food package is heated in the microwave oven is taken through the vent hole into the passage. The vapor is then entirely exhausted out through said exhaust port. Most of the vapor at a high temperature comes in contact with the central zone of the container's bottom plate and thereby accelerates heating of precooked food particularly in this zone. Thus precooked food can be evenly and quickly heated.

The container and the food package using such container both according to the present invention will be described on the basis of three specific embodiments shown by the accompanying drawings. Controlled experiments of these embodiments were conducted in comparison with the conventional embodiments as controls to clarify the effect of the invention.

Embodiment 1

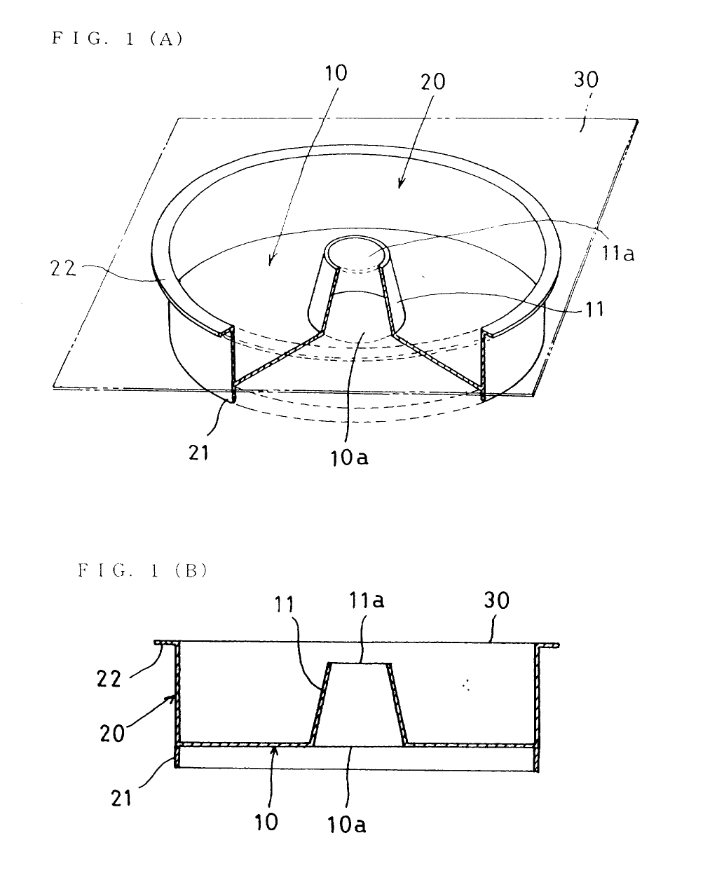

FIG. 1(A) is a perspective view showing a first embodiment of the container for precooked food adapted to be heated in microwave oven according to the present invention and FIG. 1(B) is an axially sectional view of this first embodiment.

A side wall (20) extends upward from periphery of an oval bottom plate (10). The bottom plate (10) has its inner surface dimensioned to be given by a long diameter of 135 mm×a short diameter of 115 mm and the side wall (20) has a height of 25 mm. Thus the container has an effective capacity of 220 ml.

Upper end of the side wall (20) is contiguous to a flange (22) to which a cap (30) is bonded and lower end of the side wall (20) is contiguous to a leg (21). The leg (21) having a height in order of 3˜10 mm extends downward to a level lower than the bottom plate (10) and supports the container.

The bottom plate (10) is provided substantially in its central zone with a substantially circular opening (10a). From periphery of this opening (10a), a hollow prominence (11) extending upward to a level slightly lower than an opening of the container.

It should be understood that this container is suitable to be formed by extrusion.

The container constructed as has been described above was filled with 200 g of gratin to a level lower than the level of a vent hole (11a) formed in a top of the prominence (11). Then the cap (30) was sealed and frozen at a temperature of −18° C. to obtain the food package.

This food package was entirely coated with synthetic resin film (not shown). The film was then formed below the bottom plate in the vicinity of the leg (21) with a vapor exhausting port having a diameter in order of 10 mm.

In this first embodiment of the container, the vent hole (11a) lying at the level above the upper surface of gratin communicates with the lower side of the bottom plate (10). This communication is established via the interior of the prominence

The vapor generated from the upper surface of gratin as the package is heated in the microwave oven is taken in by the vent hole (11a). The vapor then fills the interior of the prominence (11) and then is guided to the lower side of the bottom plate (10).

In this way, the portions of gratin, which have conventionally been hard to be heated, can be more quickly heated. Said portions are those lying around the prominence (11), i.e., in the vicinity of the central zone of the container and lying in the vicinity of the bottom plate (10) of the container. Experiments as will be described later demonstrated that the container according to this embodiment enables the content to be evenly and quickly heated.

While illustrated to present a substantially circular cross section, the prominence (11) may be also configured to present the other cross section such as oval or polygonal.

It is essential for the prominence (11) to have its top lying above the upper surface of precooked food filled in the container. However, the height of the prominence (11) may be appropriately adjusted depending on various factors of the article.

For example, the height of the prominence (11) may be adjusted to be substantially equal to the height of the side wall (20). It is ensured thereby that the vent hole (11a) is kept in contact with the cap (30) and a sealing performance of the container is improved. By appropriately dimensioning the height of the prominence (11), it is also possible to adjust a flowability of the vapor within the container.

Embodiment 2

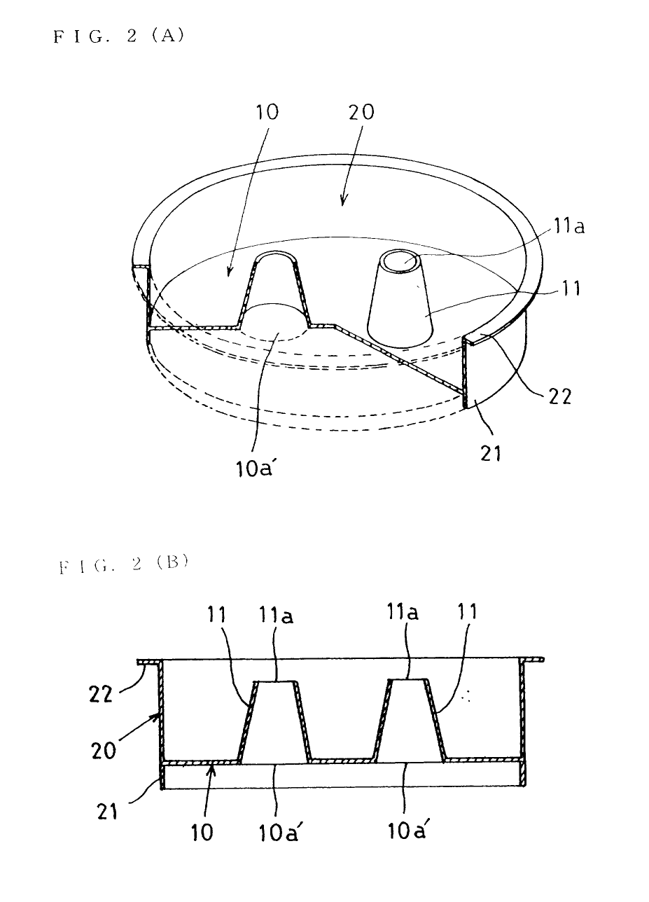

FIG. 2(A) is a perspective view showing a second embodiment of the container for precooked food adapted to be heated in microwave oven according to the present invention and FIG. 2(B) is an axially sectional view of this second embodiment.

The second embodiment is similar to the first embodiment except that there are provided a pair of the prominences (11).

The bottom plate (10) is provided in the vicinity of its central zone with a pair of substantially circular openings (10a′) (10a′). From peripheries of the respective openings (10a′) (10a′), the respective hollow prominences (11) extend upward to a level slightly lower than the level of the container's opening.

Similarly to the case of the first embodiment, the container constructed as has been described just above was filled with 200 g of gratin to a level lower than the level of the vent holes (11a) (11a) formed in tops of the respective prominences (11) (11). Then the cap (30) was sealed and frozen at a temperature of −18° C. to obtain the food package.

This food package was entirely coated with synthetic resin film (not shown). The film was then formed below the bottom plate (10) in the vicinity of the leg (21) with a vapor exhausting port having a diameter in order of 10 mm.

The food package using the container according to this second embodiment is provided with a pair of the prominences (11) (11). The heating efficiency for the portion of precooked food lying in the vicinity of the container's central zone is correspondingly improved.

Embodiment 3

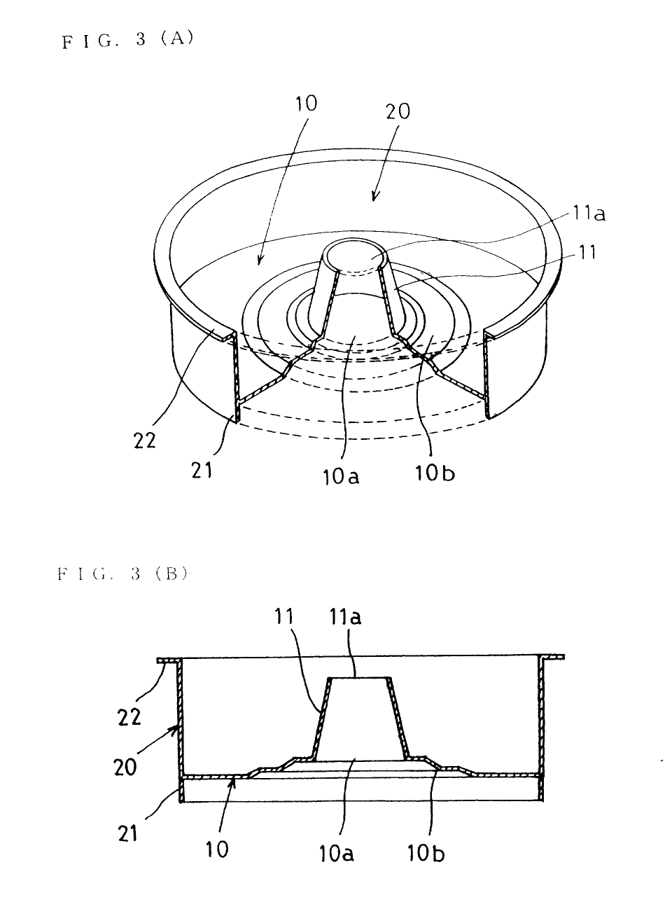

FIG. 3(A) is a perspective view showing a third embodiment of the container for precooked food adapted to be heated in microwave oven according to the present invention and FIG. 3(B) is an axially sectional view of this third embodiment.

The third embodiment is similar to the first embodiment except that the bottom plate (10) is provided with difference in level (10b).

The bottom plate (10) has its height stepwise increases toward the periphery of the opening (10a) to define the difference in level (10b).

Similarly to the case of the first embodiment, the container constructed as has been described just above was filled with 200 g of gratin to a level lower than the level of the vent hole (11a). Then the cap (30) was sealed and frozen at a temperature of −18° C. to obtain the food package.

This food package was entirely coated with synthetic resin film (not shown). The film was then formed below the bottom plate (10) in the vicinity of the leg (21) with a vapor exhausting port having a diameter in order of 10 mm.

The food package using the container according to this third embodiment is provided on the bottom plate (10) with the difference in level (10b) The bottom plate of the container has its heat exchanging area thereby enlarged. Consequently, the heating efficiency for the portion of precooked food lying in the vicinity of the container's bottom is correspondingly improved.

The difference in level is illustrated as two steps each having a slanted flat surface. However, its configuration may be freely selected so far as the heat exchanging area can be enlarged. For example, the difference in level may be provided in the form of fine many steps or fin-like construction. In addition to such difference in level, the bottom plate may be provided with a partition to guide the vapor to a desired position.

Experiments

Quality and efficiency of the respective containers according to the above-mentioned EMBODIMENTS 1˜3 were tested. To this end, the food packages using these containers were heated in the microwave oven (Model EMO-VA4 manufactured by SANYO) and temperature variations occurring in the them were observed.

Two conventional containers were used as controls.

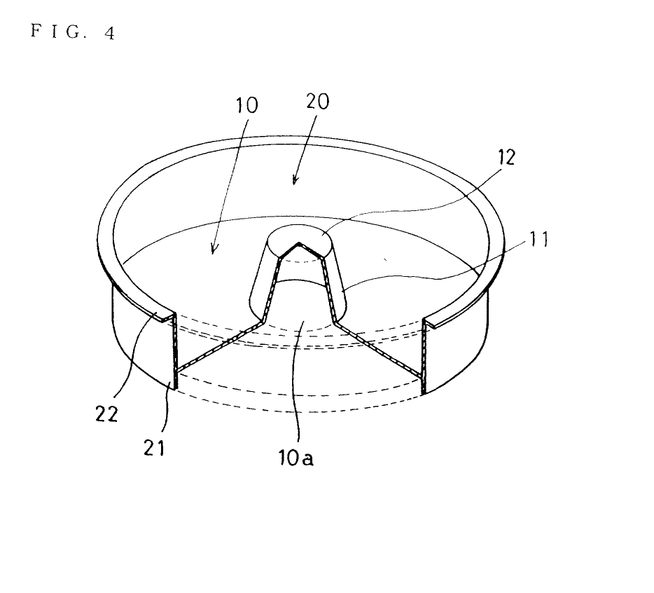

FIG. 4 is a perspective view showing a first control, which is similar to the first embodiment except that the top of the prominence (11) is sealed by the closure (12). The top of the prominence (11) is not provided with the vent hole (11a).

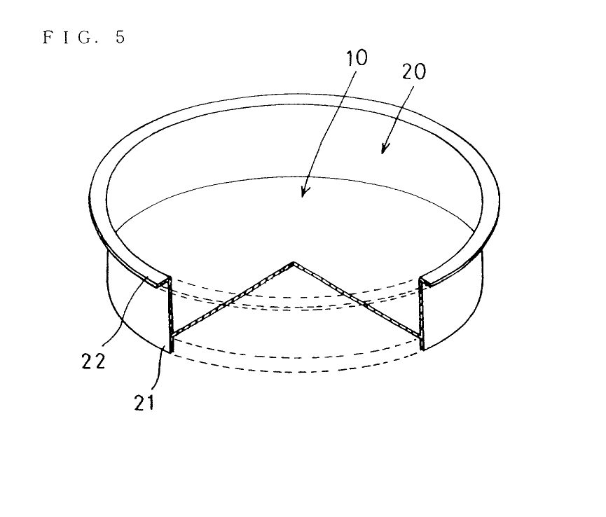

FIG. 5 is a perspective view showing a second control.

The second control is a container characterized in that the bottom plate (10) is flat and none of the prominences (11) is provided.

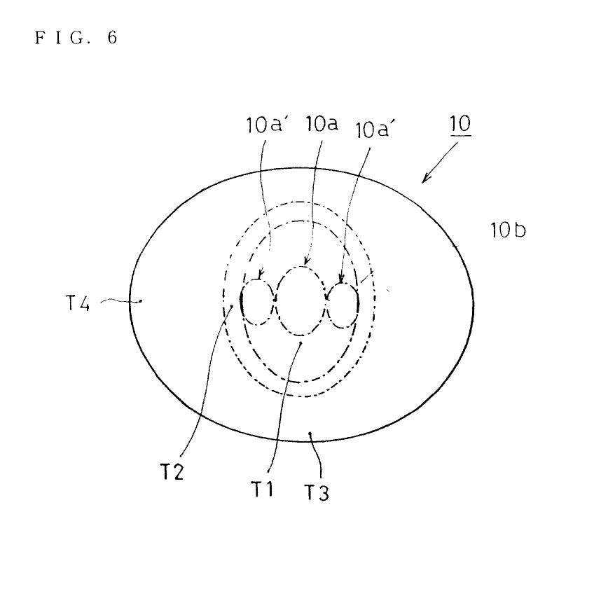

The temperature was measured at four spots (T1), (T2), (T3) and (T4) within precooked food as indicated in a plan view of FIG. 6. The temperature at these spots reached levels as indicated in TABLES 1˜3 in given periods.

TABLE 1
(After heated for 5 min.)

(° C.)

| | T1 | T2 | T3 | T4 |
|---|---|---|---|---|
| EMBODIMENT 1 | 62.1 | 57.8 | 72.3 | 76.4 |
| CONTROL 1 | 59.8 | 56.0 | 72.2 | 75.9 |
| CONTROL 2 | 18.3 | 15.5 | 72.5 | 77.3 |

TABLE 2
(After heated for 5.5 min.)

(° C.)

| | T1 | T2 | T3 | T4 |
|---|---|---|---|---|
| EMBODIMENT 1 | 77.2 | 70.3 | 76.5 | 78.3 |
| EMBODIMENT 2 | 68.5 | 72.1 | 73.2 | 77.9 |
| EMBODIMENT 3 | 73.0 | 78.0 | 73.2 | 78.2 |
| CONTROL 1 | 67.3 | 61.8 | 74.5 | 78.3 |
| CONTROL 2 | 26.5 | 22.5 | 76.1 | 80.4 |

TABLE 3
(After heated for 6 min.)

(° C.)

| | T1 | T2 | T3 | T4 |
|---|---|---|---|---|
| EMBODIMENT 1 | 81.9 | 76.6 | 80.3 | 82.0 |
| CONTROL 1 | 76.9 | 69.7 | 82.4 | 81.5 |
| CONTROL 2 | 42.3 | 37.1 | 81.1 | 85.4 |

As will be apparent from TABLES 1˜3, the food package using the container according to the first embodiment demonstrated a remarkably preferable result. Specifically, the temperatures at the central spots (T1) (T2) practically coincided with the temperatures at the peripheral spots (T3) (T4) after heated for 5.5 min. Thus the entire food package was heated up to the temperature as high as 70° C. or higher. Of the food packages using the containers of CONTROLS, even the one using the container according to CONTROL 1 required 6 min or more to this temperature.

TABLE 2 indicates also that the significant temperature rise at the central spot (T2) in EMBODIMENT 3 was caused by a high heat exchanging effect. Such high heat exchanging effect was achieved by the difference in level (10b) provided on the bottom plate (10).

TABLE 4 set forth below indicates the time required to raise the temperatures at the central spots (T1) (T2) up to 70° C. or higher. TABLE 4 indicates that the food package using the container according to EMBODIMENT 1 was entirely heated more quickly to a desired temperature than the food packages according to CONTROLS

TABLE 4

| | Time required |
|---|---|
| EMBODIMENT 1 | 5 min 27 sec |
| CONTROL 1 | 6 min 7 sec |
| CONTROL 2 | 8 min 4 sec |

The result of measurement as indicated in TABLES 1˜4 as well as the result of observation demonstrated the advantage achieved by the present invention as follows:

After the container filled with precooked food such as gratin has been heated in the microwave oven for approximately 3.5 min., vapor is generated from upper layer of the precooked food. The vapor is taken in by the vent hole (11a), filling the prominence (11), and then guided to the lower side of the bottom plate (10). The stream of vapor cooperates with the microwave to heat the portions of the precooked food lying in the vicinity of the prominence (11) and the bottom plate (10). In this manner, the temperature rise is accelerated, enabling the precooked food to be evenly and quickly heated.

Effect of the Invention

The container according to the present invention has the passage for vapor extending from the top vent hole to the lower side of the bottom plate. The vapor generated in the head space is taken in by the vent hole and guided through the interior of the prominence to the lower side of the bottom plate. In this way, the vapor at a high temperature is effectively used to achieve quick and even heating of the content. More specifically, the portions of precooked food lying in the vicinity of the container's central and lower zones are accelerated to be heated. With an advantageous consequence, individual pieces of cheese can be easily separated one from another even when these pieces are placed one upon another within the container.

What is claimed is:

1. A microwave transmissive container used to heat precooked food filled therein in a microwave oven, comprising a bottom plate, a side wall extending upward from periphery of said bottom plate and a cap bonded to upper edge of the side wall to close the container, said container being characterized by that:
said bottom plate is provided in the vicinity of its central zone with a hollow prominence extending through the bottom plate upward to a level such that a top vent hole of the prominence lies an upper space within the container so that vapor generated from upper surface of the precooked food as it is heated in the microwave oven may be taken in by the top vent hole of the prominence and guided to lower side of the bottom plate.

2. The container according to claim 1, wherein the bottom plate or side wall is provided with a leg extending downward from the bottom plate or side wall by a height of 3˜10 mm.

3. The container according to claim 1 or 2, wherein said bottom plate is provided around an opening from periphery of which the prominence extends upward with difference in level stepwise rising toward the central zone of the container.

4. A food package comprising the container according to any one of claims 1˜3 filled with precooked food adapted to be heated in microwave oven, said food package being characterized by that: vapor generated from upper surface of the precooked food as it is heated in the microwave oven may be taken in by the top vent hole of the prominence and guided to lower side of the bottom plate so that the portions of precooked food lying in the vicinity of the container's central and lower zones may be accelerated to be heated.

5. The food package according to claim 4, wherein the food package is entirely coated with synthetic resin film and a portion of this synthetic resin film coating the container's bottom is provided with an exhausting port for the vapor.

6. The food package according to claim 5, wherein the exhausting port is provided in the vicinity of the central zone of the container's bottom.
